(19) United States
(12) Patent Application Publication
(10) Pub. No.: US 2025/0286712 A1
(43) Pub. Date: Sep. 11, 2025

(54) APPARATUS FOR SECURE STORAGE OF A CRYPTOGRAPHIC KEY, A NON-TRANSITORY COMPUTER-READABLE MEDIUM AND A METHOD

(71) Applicants: Dan HOROVITZ, Rishon Lezion (IL); Yoni KAHANA, Kfar Hess (IL); Ilil BLUM SHEM-TOV, Kiryat Tivon (IL); Kobi GUETTA, Netanya (IL)

(72) Inventors: Dan HOROVITZ, Rishon Lezion (IL); Yoni KAHANA, Kfar Hess (IL); Ilil BLUM SHEM-TOV, Kiryat Tivon (IL); Kobi GUETTA, Netanya (IL)

(21) Appl. No.: 19/212,745

(22) Filed: May 20, 2025

(51) Int. Cl. H04L 9/08

(52) U.S. Cl. CPC H04L 9/0894; H04L 9/088

(57) ABSTRACT

Provided is an apparatus for secure storage of a cryptographic key. The apparatus comprises a tick value register, configured to store a tick value based on periodic tick pulses generated by a hardware-based tick source. The apparatus comprises further machine-readable instructions and processing circuitry to execute the machine-readable instructions to obtain a cryptographic key, wherein the cryptographic key is configured to be valid for a maximum tick value. The processing circuitry is further to execute the machine-readable instructions to receive a request to use the cryptographic key from a requestor. The processing circuitry is further to execute the machine-readable instructions to determine if the cryptographic key is valid based on the maximum tick value of the cryptographic key and the current tick value of the tick value register following the request.

### BACKGROUND

In the field of secure computing systems, it may be a challenge to ensure that cryptographic operations are performed in a controlled, verifiable, and self-contained manner. For example, systems may be designed to enforce cryptographic key usage policies based on conditions such as time, usage count, or operational context, often without relying on external infrastructure. This may be relevant in scenarios where devices operate in disconnected or restricted environments, including air-gapped systems, embedded platforms, and regulated domains.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus for secure storage of a cryptographic key;

FIG. 2 illustrates a flowchart of an example of a method; and

FIG. 3 illustrates an example of a system for secure and time-limited usage of cryptographic keys based on tick-based expiration.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

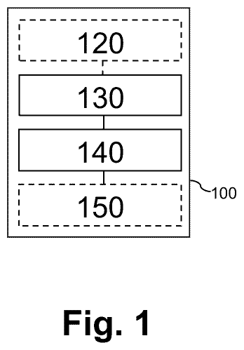

FIG. 1 illustrates a block diagram of an example of an apparatus for secure storage of a cryptographic key 100 or device for secure storage of a cryptographic key 100. The apparatus for secure storage of a cryptographic key 100 comprises circuitry that is configured to provide the functionality of the apparatus for secure storage of a cryptographic key 100. For example, the apparatus 100 of FIG. 1 comprises (optional) interface circuitry 120, processing circuitry 130, a tick value register 140 and (optional) storage circuitry 150. For example, the processing circuitry 130 may be coupled the tick value register and optionally with the interface circuitry 120 and storage circuitry 150.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 150. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 150, which may correspond to or be implemented by the storage circuitry 150. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 150 or means for storing information 150.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 150 or means for storing information 150 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

For example, the apparatus 100 may be a secure key storage configured to store, and manage cryptographic keys in a manner that prevents unauthorized access and enforces hardware-level policies for key validity and usage. The secure key storage may be isolated from general-purpose software environments and may allow internal access to cryptographic keys only under defined hardware-enforced conditions. In some examples, a host system may be connected to the apparatus 100 and the host system and the apparatus may interact through the interface circuitry 120. The apparatus 100 may operate independently of the host's trust level and may ensure that all time-based access control decisions are enforced in hardware, protecting the cryptographic key even if the host is compromised.

The apparatus 100 comprises a tick value register 150. The tick value register 150 is configured to store a tick value based on periodic tick pulses generated by a hardware-based tick source. For example, the tick value register 140 may be a hardware component of the apparatus 100 configured to store a numerical value that represents a counter which increases incrementally in response to a periodic signal. The tick value register 140 may be implemented as a dedicated register or memory cell in hardware and may be designed to support monotonically increasing behavior without reset or rollback, thereby serving as a trusted representation of elapsed time or activity. The tick value register 140 may be configured to receive tick pulses from a hardware-based tick source and update the tick value accordingly.

In some examples, the tick value register 150 may be incremented on each periodic tick pulse received from the hardware-based tick source. The tick value register 150 may be implemented within a secure hardware module and may be logically or physically coupled to a secure key storage system, such as apparatus 100. The tick value stored in the tick value register may be used to determine whether a cryptographic key remains valid, such that the value of the tick value register acts as a time base against which a maximum tick value for the cryptographic key may be compared.

For example, a hardware-based tick source may be a hardware-integrated timing component configured to generate a sequence of periodic timing signals that represent discrete intervals of time, independently of an operating system, firmware-level software, or external network-based time synchronization. A hardware-based tick source may be designed to provide a reliable, tamper-resistant time base within the apparatus, and may be implemented as part of an oscillator-based subsystem, a real-time clock module, or a timer circuit. The hardware-based tick source may be configured to operate autonomously or semi-autonomously, and may function within a secure or always-on domain of the platform to ensure continuity of timing operations even when the main processing logic is suspended or powered down.

In some examples, the hardware-based tick source may comprise a clock signal derived from a time signal of a processing circuitry connected to the apparatus 100, such as processing circuitry 130 or a processor core, a microcontroller, or a secure enclave. For example, a dedicated path may be used to derive periodic tick pulses from the clock signal for the purpose of incrementing a tick value register. In some examples, the hardware-based tick source may include a time signal provided by a hardware-based real-time clock (RTC) connected to the apparatus 100, such as an RTC circuit supported by a crystal oscillator and optionally powered by a backup battery to maintain timekeeping during system shutdown.

For example, the periodic timing signals generated by the hardware-based tick source may be referred to as the periodic tick pulses. The periodic tick pulses may be regularly recurring digital signals generated by the hardware-based tick source, where each pulse represents a discrete and uniform unit of elapsed time. Periodic tick pulses may be produced with fixed timing intervals and may be used to trigger the update of time-sensitive state information, such as counters, timers, or cryptographic control logic. The periodic tick pulses may propagate internally through the apparatus 100 and may be consumed directly by tick value register 140 without exposure to software components or external systems.

In some examples, the periodic tick pulses may be derived from an underlying clock signal generated by a processing circuitry or a hardware-based real-time clock, and may occur at a constant frequency such as one pulse per microsecond, millisecond, or other uniform time interval. The periodic tick pulses may be used to trigger internal time-dependent actions, such as incrementing the tick value register. The periodic tick pulses may not be exposed outside of the hardware module and may be used exclusively within the apparatus to maintain a tamper-resistant internal notion of elapsed time.

For example, the tick value may be a numeric quantity stored in the tick value register 140 and representing the cumulative count of periodic tick pulses received from the hardware-based tick source since a defined reference event. For example, the reference event from which the tick value may begin accumulating may be a predefined system or application-specific trigger that defines the initial moment of the tick count lifecycle. For example, the reference event may be the generation of a cryptographic key, the provisioning of a cryptographic key into secure storage, the activation of a secure subsystem, or the reset of the tick value register upon creation of a new time-restricted data object. For example, the tick value may begin incrementing from zero or another known baseline value at the occurrence of the reference event and may continue to increment in response to each periodic tick pulse generated thereafter. The tick value is maintained within the secure tick value register 140.

In some examples, the tick value may be automatically updated in response to the periodic tick pulses generated by the hardware-based tick source. In some examples, the tick value register may be configured to increment the tick value monotonically. That is, the tick value may act as a discrete time counter that increases monotonically as time progresses, and may be used internally to evaluate time-dependent conditions, such as the validity of a cryptographic key. Each incoming tick pulse may cause the tick value to increment by one, thereby reflecting the total number of discrete time units that have elapsed. The updating of the tick value may be handled by hardware, for example the tick value register 140, and may proceed even when the main system processor is inactive.

The processing circuitry 130 is configured to obtain a cryptographic key. The cryptographic key is configured to be valid for a maximum tick value. For example, the cryptographic key may be generated by the processing circuitry 130. For example, the cryptographic key may be obtained by the processing circuitry 130 from the storage circuitry 150. For example, the cryptographic key may be generated by an external source. In some examples, the processing circuitry 130 may obtain the cryptographic key from the external source, for example via the interface circuitry 120. The processing circuitry 130 may initiate this operation autonomously or in response to a request received through the interface circuitry.

For example, the cryptographic key may be a structured binary data object that serves as the basis for performing cryptographic operations, including but not limited to encryption, decryption, digital signature generation, authentication, and integrity verification. The cryptographic key may be represented as a fixed-length or variable-length sequence of bits and may be formatted according to cryptographic standards, such as AES-128, RSA-2048, or ECC-P256. The cryptographic key may be associated with a unique identifier, metadata, and algorithm-specific usage constraints, and may be managed exclusively within hardware logic configured for secure operation. The cryptographic key may be used by an internal cryptographic engine within the host system, and access to the cryptographic key may be conditional on hardware-based policies. The cryptographic key may be configured to support a time-based encryption model by being valid only for a maximum tick value, where the tick value reflects the discrete progression of time within the apparatus. This configuration may result in a cryptographic key that is bound to a temporal usage constraint: once the tick value exceeds the defined maximum tick value, the cryptographic key may no longer be permitted for use in cryptographic operations and may be logically invalidated or physically deleted by the apparatus.

In some examples, the cryptographic key may be a symmetric key or a private key of a private-public key pair. The symmetric key may be used in algorithms such as AES, ChaCha20, or other shared-key systems, where the same key is used for both encryption and decryption. The private key of a private-public key pair may be used in asymmetric schemes such as RSA or elliptic curve cryptography, where the private key enables decryption or signing, and the corresponding public key remains openly available for verification or encryption. The cryptographic key may include additional parameters such as usage flags, expiration metadata, or associated identity attributes, which may be evaluated in combination with the tick-based validity condition to ensure proper and timely usage within cryptographic protocols. The combination of temporal validity and secure hardware confinement may enable the apparatus to support time-based encryption mechanisms that enforce expiration of cryptographic functionality based solely on internal tick progression, without reliance on external time sources or trusted third-party systems

For example, the generation of the cryptographic key by the key generation entity (for example the processing circuitry 130 or the external source) may be accompanied by a configuration process that establishes a time-bound usage period for the cryptographic key enforced and defined by the maximum tick value. During generation of the cryptographic key, an expiration date may be received as an input parameter. The expiration date may define the intended validity duration of the cryptographic key, and may represent a fixed or relative point in time after which the cryptographic key is to be considered no longer usable. Because the apparatus 100 does not rely on a wall-clock time source, the expiration date may be transformed into a representation that is compatible with the tick-based pulses of the hardware-based tick source of the apparatus 100. In some examples, the expiration date may be converted into an expiration interval expressed in the discrete tick units, based on the frequency of the periodic tick pulses generated by the hardware-based tick source. The hardware-based tick source may emit periodic tick pulses at a known and stable rate, such as one pulse per millisecond, and each tick pulse may correspond to a single unit of time within the apparatus. The conversion of the expiration date into an expiration interval may be based on multiplying the intended duration, expressed in real-time units such as seconds or minutes, by the frequency of the periodic tick pulses. The expiration interval may therefore reflect the number of periodic tick pulses that are expected to occur before the cryptographic key should expire.

Further, the current tick value from the tick value register is received by the key generation entity (for example, the processing circuitry 130 or the external source) at the time the cryptographic key is generated. The current tick value may indicate the number of periodic tick pulses that have occurred since the reference point as described above. Then the maximum tick value for the cryptographic key is determined by adding the expiration interval to the current tick value. This maximum tick value may define the latest permissible tick value for which the cryptographic key remains valid.

In some examples, processing circuitry 130 may be further configured to obtain the maximum tick value of the cryptographic key. For example, if the key is generated by the external source the processing circuitry may obtain the maximum tick value together with the cryptographic key via the interface circuitry 120. For example, if the key is generated by the processing circuitry 130 the maximum tick value may be obtained from the storage circuitry 150.

The maximum tick value may be stored may be stored in a secure memory. For example, the maximum tick value may be stored in a secure maximum tick register. In some examples, the apparatus 100 may further comprise the maximum tick value register which is configured to store the maximum tick value of the cryptographic key. For example, the maximum tick value register may be a hardware-based storage element. The maximum tick value register may be implemented as a dedicated register or secure memory cell that is protected against modification after provisioning, and may be accessible only to internal hardware logic for the purpose of comparing against the current tick value to enforce time-based access restrictions. The content of the maximum tick value register may remain immutable during the operational lifetime of the cryptographic key, ensuring that the key expiration condition is enforced in a tamper-resistant and deterministic manner.

In some examples, the processing circuitry 130 may be further to store the cryptographic key in a secure key storage. In some examples, the apparatus 100 may comprise the secure key storage configured to store the cryptographic key. For example, the secure key storage may be a hardware-based storage component configured to store cryptographic keys in a manner that prevents unauthorized access, observation, or extraction by software, operating systems, or external interfaces. The secure key storage may be implemented as part of the dedicated storage circuitry 150 and may include tamper-resistant design features, such as physical shielding, access control logic, and monitoring mechanisms for detecting probing or voltage manipulation attempts. The secure key storage may support write-once or write-protected regions to ensure the immutability of sensitive parameters, such as cryptographic key material and associated expiration metadata, including the maximum tick value.

In some examples, the secure key storage may be implemented using non-volatile memory cells embedded in a hardware security module, a system-on-chip security enclave, or a cryptographic accelerator unit. The secure key storage may operate under the exclusive control of internal hardware logic and may allow cryptographic keys to be used only by authorized internal components, such as a cryptographic engine, without ever exposing the key material outside the protected boundary of the apparatus.

In some examples, the cryptographic key may be stored in the secure key storage that is inaccessible by an operating system running on a host connected to the apparatus 100. This inaccessibility may be enforced through hardware-level isolation mechanisms that prevent software, including privileged system software or hypervisors, from directly reading, modifying, or exporting the contents of the secure key storage. The interface between a host system and the apparatus 100 may be restricted to high-level operations, such as provisioning, usage requests, or status queries, without granting any access to the underlying key material. In some examples, the secure key storage may be implemented within a secure execution environment or hardware security module that physically and logically separates the cryptographic key storage from external memory-mapped interfaces. The processing circuitry 130 may act as the only authorized pathway to interact with the cryptographic key and may permit access exclusively for internal cryptographic operations, such as encryption, decryption, or signing, without exposing the cryptographic key to the host.

The processing circuitry 130 is further configured to receive a request to use the cryptographic key from a requestor. For example, the requestor may be any component or entity that initiates a cryptographic operation involving the cryptographic key. The requestor may be an application, a service, or a software module running on the host system, such as a user-space process, a system-level driver, or a secure communication stack. The requestor may reside within the operating system of the host system or operate at a lower layer, such as firmware or a hypervisor, depending on the security architecture. In some examples, the request to use the cryptographic key may be transmitted from the requestor to the apparatus via the interface circuitry 120, using defined communication protocols or hardware signaling mechanisms. The requestor may not have direct access to the cryptographic key or the secure key storage, but may instead invoke a function, such as decryption, authentication, or signing. which is to be performed internally by the apparatus using the stored cryptographic key.

The processing circuitry 130 is further configured to determine if the cryptographic key is valid based on the maximum tick value of the cryptographic key and the current tick value of the tick value register following the request. For example, the processing circuitry 130 may be configured to evaluate whether the cryptographic key is still valid at the time a request is received by comparing the current tick value, retrieved from the tick value register, with the maximum tick value associated with the cryptographic key. This comparison may be performed as part of the request handling process, ensuring that cryptographic keys are only used within their permitted tick-based validity window. The validity check may be executed each time the cryptographic key is requested, providing real-time enforcement of expiration policies. If the current tick value is lower than the maximum tick value, the processing circuitry 130 may allow the cryptographic operation to proceed. If the current tick value has reached or exceeded the maximum tick value, the cryptographic key may be considered expired and access to it may be denied or revoked by the apparatus.

The above-described apparatus 100 provides a secure mechanism for time-limited usage of cryptographic keys without relying on external time sources, software-based timers, or trusted third-party services. By basing key validity on a hardware-based tick source that generates periodic tick pulses, and by enforcing expiration through hardware-level comparison between a current tick value and a maximum tick value associated with each cryptographic key, the apparatus 100 enables precise, tamper-resistant control over the lifecycle of cryptographic keys. The use of a secure tick value register and non-modifiable maximum tick value ensures that expiration enforcement cannot be bypassed or manipulated by an operating system or host system software.

The above-described apparatus 100 enables reliable deployment in air-gapped systems and other isolated environments where real-time clocks, network time synchronization, or centralized key management infrastructure may be unavailable or untrusted. The cryptographic key might not be exposed outside the secure boundaries of the apparatus 100 and may be used internally if its tick-based validity condition is satisfied. This provides resilience against both software-based attacks and physical tampering attempts aimed at extending key lifetimes or circumventing access controls, making the apparatus suitable for use in compliance-critical or highly sensitive computing platforms.

In some examples, the processing circuitry 130 may be further configured to authorize access to the cryptographic key for the requestor if it is determined that cryptographic key is valid. For example, the this may occur when the current tick value, derived from the tick value register 140, is strictly less or less or equal than the maximum tick value associated with the cryptographic key. Upon confirming this condition, the processing circuitry 130 may enable the cryptographic key to be internally released to a cryptographic engine for use in executing the requested operation, such as decryption, authentication, or digital signing. The authorization process may occur entirely within the secure boundary of the apparatus and may not expose the key material to the host or the requestor. The cryptographic key may be temporarily unlocked for one-time internal usage or may be flagged as active within the apparatus, depending on the key management policy implemented in hardware.

In some examples, the processing circuitry 130 may be further configured to provide an indication of a validity status of the cryptographic key to the requestor if it is determined that the cryptographic key is valid. For example, this may occur when the current tick value, derived from the tick value register 140, is strictly less or less than or equal to the maximum tick value associated with the cryptographic key. Upon confirming this condition, the processing circuitry 130 may generate a status response indicating that the cryptographic key is valid, and may transmit this status information to the requestor without releasing or using the cryptographic key itself. The validity status may be provided through the interface circuitry 120, using a secured or controlled communication protocol that prevents exposure of the cryptographic key material. In this configuration, the cryptographic key may remain stored securely within the secure key memory and may not be forwarded to any cryptographic engine unless separately authorized. This behavior may be particularly beneficial in use cases where the requestor only requires confirmation of key validity for decision-making purposes, without direct usage of the key for cryptographic operations.

In some examples, the processing circuitry 130 may be further configured to delete or invalidate the cryptographic key if it is determined that cryptographic key is not valid. For example, the deletion or invalidation process may be triggered automatically and irrevocably as part of the tick-based enforcement mechanism. Deletion may involve securely erasing the cryptographic key from the secure key storage, such as by zeroization, overwriting, or disconnection from the internal reference index. In some examples, the apparatus 100 may mark the cryptographic key as invalidated by setting a hardware-protected flag, rendering the key unusable for all future operations. This action may be enforced at the hardware level and may occur without intervention from software, ensuring that no expired key can be accessed or misused beyond its predefined lifetime.

In some examples, determining if the cryptographic key as valid comprises comparing the current tick value with the maximum tick value of the cryptographic key following the request. For example, this comparison may occur at the time a request is received, and may form the core logic used to decide whether to grant or deny key access. The current tick value may represent the number of periodic tick pulses that have occurred since a reference point as described above, and may be compared against the stored maximum tick value, which represents the tick threshold computed at the time of key provisioning. If the current tick value is less or less or equal than the maximum tick value, the key may be deemed valid. Otherwise, the cryptographic key may be considered expired.

In some examples, the processing circuitry 130 may be further configured to determine that the cryptographic key is valid if the current tick value is lower than the maximum tick value of the cryptographic key following the request. In some examples, the processing circuitry 130 may be further configured to determine that the cryptographic key is valid if the current tick value is equal to the maximum tick value of the cryptographic key following the request. This determination may serve as the logical condition for activating the key, and may be checked automatically for each request received by the apparatus.

In some examples, apparatus may be configured for operation in an air-gapped environment without access to external network time services. For example, an air-gapped environment may be a computing system or deployment scenario in which the apparatus 100 is physically or logically isolated from external networks, including the internet or any other communication infrastructure that may introduce security risks. In such environments, the apparatus 100 may not be permitted to exchange data with external systems, and may operate under strict constraints that prevent remote access, online updates, or real-time synchronization with external services. Air-gapped environments may be used in critical infrastructure, defense systems, classified data centers, or industrial control systems where data confidentiality, integrity, and operational autonomy are paramount. In some examples, external network time services may refer to online or remotely accessible time synchronization sources, such as Network Time Protocol (NTP) servers, GPS time signals, or cloud-based time attestations. These services may provide real-time clock information to synchronize distributed systems but may not be trustworthy or accessible in isolated environments.

In some examples, the apparatus 100 may therefore be configured to operate entirely without access to external time sources, such as network-based time synchronization services or centralized time attestation infrastructures. Instead of relying on externally provided real-time clock values, which may be unavailable, untrusted, or vulnerable to manipulation in isolated environments, the apparatus 100 may use an internal hardware-based tick source that generates periodic tick pulses at a known and stable frequency as described above. Because the tick value is derived exclusively from the hardware-based tick source and updated independently of software or network interfaces, it may provide a secure, deterministic, and tamper-resistant mechanism for tracking elapsed time. This internal timekeeping capability may allow the apparatus to enforce expiration policies for cryptographic keys based on a comparison between the current tick value and a maximum tick value associated with each key. As a result, time-based control over key validity may be achieved entirely within the boundaries of the apparatus, even in environments that are physically or logically air-gapped, and without any dependency on external clocks, synchronized time protocols, or third-party trust anchors.

For example, the apparatus 100 may further comprise a power source configured to maintain operation of the hardware-based tick source. For example, the may be used during periods when the host system is powered off or in a low-power state. This power source may be implemented as a dedicated auxiliary supply, such as a coin-cell battery, a supercapacitor, or an always-on voltage rail that supports a low-power domain within the apparatus 100 or within the host system. The inclusion of this power source may allow the hardware-based tick source to continue generating periodic tick pulses without interruption, ensuring that the tick value register continues to increment even when the processor circuitry or system logic is not active. By sustaining the tick source through a dedicated power supply, the apparatus 100 may guarantee that time continues to progress in a secure and tamper-resistant manner, making it possible to enforce expiration policies even across power cycles, reboots, or suspend states.

In some examples, the apparatus 100 may further comprise the cryptographic engine configured to perform one or more cryptographic operations using the cryptographic key. For example, the cryptographic engine may be a dedicated hardware component configured to execute cryptographic algorithms using cryptographic keys that are stored and managed within in the secure key storage. The cryptographic engine may be implemented as part of a hardware security module, a secure element, a system-on-chip security block, or an integrated encryption accelerator. The cryptographic engine may operate entirely within the secure boundary of the apparatus 100 and may be the only internal component authorized to receive and use the cryptographic key after a request has been evaluated and the key has been validated. For example, the cryptographic key may be transferred to the cryptographic engine by the processing circuitry 130 through a secure internal path that is not accessible to external interfaces or software components running on the host system. The cryptographic engine may not expose the key material and may process data internally, returning only the cryptographic result of an operation.

In some examples, the cryptographic engine may be configured to perform symmetric encryption or decryption using keys such as AES-128 or AES-256, or asymmetric operations such as RSA decryption, digital signature generation, or elliptic curve computations. The cryptographic engine may also support authentication protocols, key derivation functions, or integrity verification mechanisms. For instance, when the requestor from the host system submits a request to decrypt data or verify a digital signature, the processing circuitry 130 may validate that the cryptographic key is still within its permitted tick-based validity window, and then forward the key to the cryptographic engine for secure use. All cryptographic operations may be executed within the apparatus in a closed and protected environment, ensuring that the cryptographic key is never exposed or exported, and that its use is strictly governed by the hardware-enforced tick-based access control model.

In some examples, the processing circuitry 130 may be further configured to forward the cryptographic key only to the cryptographic engine upon determining that the cryptographic key is valid. This forwarding operation may use a secure, non-exportable hardware path to transfer the cryptographic key from the secure key memory to the cryptographic engine. By enforcing this condition, the apparatus 100 may ensure that the cryptographic key is not used, processed, or exposed unless its tick-based validity condition is satisfied, thereby preserving strict temporal access control and ensuring that expired keys are never utilized in any cryptographic operation.

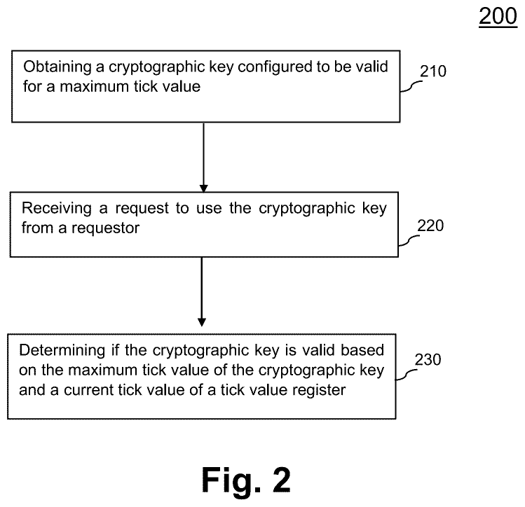

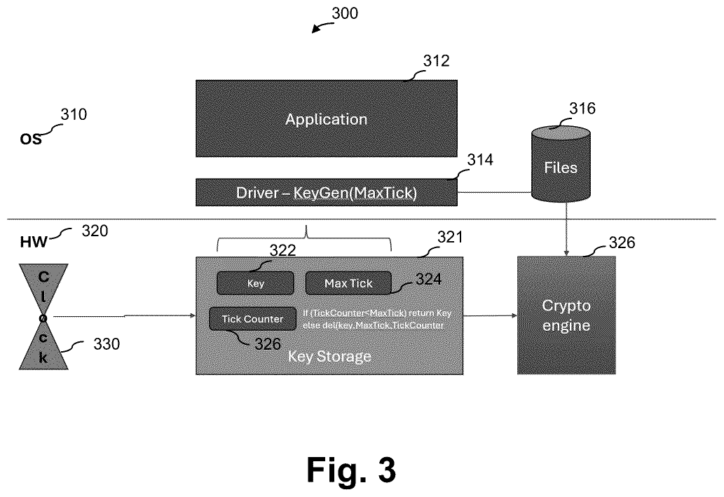

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-3).

FIG. 2 illustrates a flowchart of an example of a method 200. The method 200 may, for instance, be performed by an apparatus as described herein, such as apparatus 100. The method 200 comprises obtaining 210 a cryptographic key. The cryptographic key is configured to be valid for a maximum tick value. The method 200 comprises further receiving 220 a request to use the cryptographic key from a requestor. The method 200 comprises further determining 230 if the cryptographic key is valid based on the maximum tick value of the cryptographic key and a current tick value of a tick value register following the request. The tick value register is configured to store a tick value based on periodic tick pulses generated by a hardware-based tick source.

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIG. 3).

### FURTHER EXAMPLES

FIG. 3 illustrates an example of a system 300 for secure and time-limited usage of cryptographic keys based on tick-based expiration. The system 300 comprises components operating system (OS) layer 310 and a hardware layer (HW) 320. The operating system layer 310 may comprise an application 312 and a driver 314 configured to interface with the apparatus. The application 312 may request cryptographic services, while the driver 314 includes a function (KeyGen(MaxTick)) that provisions as cryptographic key with an associated maximum tick value, that is a time-bound usage limit expressed in system ticks. The driver 314 may communicate this provisioning request to the key storage 321 and may also interact with a file system 316 to access or store encrypted data. In some examples, when a new cryptographic key is provisioned via the driver using the KeyGen(MaxTick) command, the tick counter register 326 may be reset to zero as part of the initialization sequence, anchoring the tick-based expiration window to the moment of key generation.

The hardware layer 320 comprises a hardware-based tick source 330 (labeled “Clock”), a secure key storage unit 321 and a cryptographic engine 326. The secure key storage 321 includes memory regions 322 for storing a cryptographic key and a maximum tick value register 326 associated with that key and a tick value register 324 (labelled “Tick Counter”). The hardware-based tick 330 source may generate periodic tick pulses at a known and stable rate, such as 1 kHz, which are used to increment the tick value register 326 within the secure key storage unit 321. The tick counter may represent the elapsed time since a defined point (e.g., system initialization or key provisioning) in discrete tick units.

The secure key storage unit 321 comprises processing circuitry that performs the validity check: if the current tick counter is less than the maximum tick value, the key may be forwarded to the cryptographic engine 326 for internal use. If the current tick value is equal to or exceeds the maximum tick value, the key may be securely deleted or invalidated, and the tick counter may optionally be reset. This check-and-delete function ensures that time-based expiration is enforced entirely in hardware, without requiring intervention from the operating system.

The hardware-based tick source may be implemented using a Real-Time Clock (RTC) module, which may continue operating during power-down states if supported by a battery backup, such as a coin-cell battery. This enables tick-based key expiration to remain reliable across reboots, hibernation, or power loss. The tick counter 326 may be latched to the hardware-based tick source and incremented independently of the host system. The secure key memory 32 may be physically protected and isolated from host access, ensuring that the cryptographic key can never be exported or read by the application 312 or any software layer. Instead, the key is transferred securely and internally to the cryptographic engine 326 for authorized operations.

This system 300 allows to enforce key usage based on a trusted measure of elapsed time, derived from periodic tick pulses, rather than relying on system time or external time attestations. As such system may rely only on platform clock timers to measure the ticks (/time) left for a key that is managed at the hardware level 320. Once provisioned, there might not be any dependency on a centralized server and the system may be good for air gaped systems where no access to network-based time services is available, and it is foolproof against tampering with the system settings. The system 300 might not be dependent on third party nor on the OS time that can be tampered an also provides solution for hardware attackers. By combining a hardware-based clock, secure tick counting, and isolated cryptographic execution, the system 300 provides a robust framework for secure, autonomous, time-restricted access control to cryptographic material. A revocation mechanism that does not rely on time-related conditions may also be implemented by securely deleting the cryptographic key from the secure key memory. This may serve as a parallel or fallback control path to the tick-based expiration logic, ensuring that compromised or obsolete keys can be removed even before their natural expiration point is reached.

For example, the system 300 may be used in scenarios where data protection must comply with legal, regulatory, or business-specific time constraints, including applications such as digital rights management (DRM), subscription access control, and confidential communications with limited access periods.

The system 300 may use the described tick-based mechanism to enforce the time-limited validity of cryptographic keys. This mechanism may be inherently resistant to manipulation by external software or hardware due to its tight integration into secure hardware logic and its reliance solely on internally generated tick pulses.

In some examples, the tick value is maintained in the tick value register located inside secure key memory. The only input to this register may be the periodic tick pulses generated by a hardware-based tick source. This design may prevent malicious software or external hardware from reprogramming or influencing the tick progression. Even if the real-time clock (RTC) or oscillator is targeted by an attacker, the system 300 does not rely on externally configurable time but only on the continuous tick pulses. If the secure key memory were compromised, the tick logic could be affected, but in such a case, the broader integrity of the system would already be breached. Such attacks are considered expensive and difficult to persist across power cycles or reboots and are not unique to this system.

The tick signal might not carry data and is not transmitted over an externally accessible communication bus. Because the tick value register may be incremented solely by clock pulses, no bus-level protection may be needed to defend against man-in-the-middle attacks or spoofing. The signal is routed internally within hardware and serves only to update the tick value monotonically.

In some configurations, the tick source may be based on a crystal oscillator, which may be manipulated, for example, slowed down to delay key expiration. However, if such manipulation causes the tick frequency to fall outside the valid range, the system as a whole will no longer behave correctly. This means that a “slowed clock” might not extend key validity without also degrading system stability. An edge case may involve slowing the clock only during low-power modes, then restoring it during active use to stealthily extend key validity. This may be mitigated by integrating the oscillator within the secure hardware boundary of the key storage and protecting it with tamper detection. Furthermore, the nominal tick frequency may be stored and monitored to detect any frequency deviation. If such deviation is detected, the system may preemptively invalidate the cryptographic key to preserve security.

Compared to other solutions such as Trusted Platform Module 2.0 (TPM 2.0) the tick-based system 300 described above might not depend on trusted wall-clock time or externally programmable time policies. Existing solutions may require complex integration and a reliance on system-level software or external attestation services. System 300 determines time solely as the difference between the current tick value and the tick value at the point of cryptographic key provisioning, both of which are tracked and enforced entirely in hardware. This architecture eliminates the need for time synchronization, remote validation, or trust in privileged software components.

The system 300 proves platform-independent mechanism for binding key usage to internal tick progression. It may further combine tick counting with key storage and time-based usage enforcement in a lightweight and secure way that is especially useful for isolated or air-gapped use cases. No external time sources are needed. Instead, the system 300 simply counts hardware clock ticks internally, and defines a tick offset that determines the expiration point of a cryptographic key. Any deviation from the expected tick behavior, such as underclocking, may be detected and used to trigger key invalidation, ensuring that time-based usage control is reliably enforced in hardware.

Further details and aspects are mentioned in connection with the examples described above. The example shown in FIG. 3 may include one or more optional additional features corresponding to one or more aspects mentioned in connection with the proposed concept or one or more examples described above (e.g., FIGS. 1-2).

In the following, some examples of the proposed concept are presented:

An example (e.g., example 1) relates to an apparatus for secure storage of a cryptographic key comprising a tick value register, configured to store a tick value based on periodic tick pulses generated by a hardware-based tick source, machine-readable instructions and processing circuitry to execute the machine-readable instructions to obtain a cryptographic key, wherein the cryptographic key is configured to be valid for a maximum tick value, receive a request to use the cryptographic key from a requestor, determine if the cryptographic key is valid based on the maximum tick value of the cryptographic key and the current tick value of the tick value register following the request.

Another example (e.g., example 2) relates to a previous example (e.g., example 1) or to any other example, further comprising that the processing circuitry is further to execute the machine-readable instructions to authorize access to the cryptographic key for the requestor if it is determined that cryptographic key is valid.

Another example (e.g., example 3) relates to a previous example (e.g., one of the examples 1 to 2) or to any other example, further comprising that the processing circuitry is further to execute the machine-readable instructions to delete the cryptographic key if it is determined that cryptographic key is not valid.

Another example (e.g., example 4) relates to a previous example (e.g., one of the examples 1 to 3) or to any other example, further comprising that determining if the cryptographic key as valid comprises comparing the current tick value with the maximum tick value of the cryptographic key following the request.

Another example (e.g., example 5) relates to a previous example (e.g., one of the examples 1 to 4) or to any other example, further comprising that the processing circuitry is further to execute the machine-readable instructions to determine that the cryptographic key is valid if the current tick value is lower than the maximum tick value of the cryptographic key following the request.

Another example (e.g., example 6) relates to a previous example (e.g., one of the examples 1 to 5) or to any other example, further comprising that the processing circuitry is further to execute the machine-readable instructions to obtain the maximum tick value of the cryptographic key.

Another example (e.g., example 7) relates to a previous example (e.g., one of the examples 1 to 6) or to any other example, further comprising that the processing circuitry is further to execute the machine-readable instructions to store the cryptographic key in a secure key storage.

Another example (e.g., example 8) relates to a previous example (e.g., one of the examples 1 to 7) or to any other example, further comprising a secure key storage configured to store the cryptographic key.

Another example (e.g., example 9) relates to a previous example (e.g., one of the examples 7 or 8) or to any other example, further comprising that the cryptographic key is stored in the secure key storage that is inaccessible by an operating system running on a host connected to the apparatus.

Another example (e.g., example 10) relates to a previous example (e.g., one of the examples 1 to 9) or to any other example, further comprising that the hardware-based tick source generating the periodic tick pulses comprises a clock signal based on a time signal of a processing circuitry connected to the apparatus or of a hardware-based real-time clock connected to the apparatus.

Another example (e.g., example 11) relates to a previous example (e.g., one of the examples 1 to 10) or to any other example, further comprising a power source configured to maintain operation of the hardware-based tick source.

Another example (e.g., example 12) relates to a previous example (e.g., one of the examples 1 to 11) or to any other example, further comprising a maximum tick value register being configured to store the maximum tick value of the cryptographic key.

Another example (e.g., example 13) relates to a previous example (e.g., one of the examples 1 to 12) or to any other example, further comprising that the cryptographic key is a symmetric key or a private key of a private-public key pair.

Another example (e.g., example 14) relates to a previous example (e.g., one of the examples 1 to 13) or to any other example, further comprising that the apparatus is configured for operation in an air-gapped environment without access to external network time services.

Another example (e.g., example 15) relates to a previous example (e.g., one of the examples 1 to 14) or to any other example, further comprising that the tick value register is configured to increment the tick value monotonically.

Another example (e.g., example 16) relates to a previous example (e.g., one of the examples 1 to 15) or to any other example, further comprising a cryptographic engine configured to perform one or more cryptographic operations using the cryptographic key.

Another example (e.g., example 17) relates to a previous example (e.g., example 16) or to any other example, further comprising that the processing circuitry is further configured to execute the machine-readable instructions to forward the cryptographic key only to the cryptographic engine upon determining that the cryptographic key is valid.

An example (e.g., example 18) relates to a non-transitory computer-readable medium storing instructions that, when executed by one or more processing circuitries, causing the one or more processing circuitries to perform a method comprising obtaining a cryptographic key, wherein the cryptographic key is configured to be valid for a maximum tick value, receiving a request to use the cryptographic key from a requestor, determining if the cryptographic key is valid based on the maximum tick value of the cryptographic key and a current tick value of a tick value register following the request, wherein the tick value register is configured to store a tick value based on periodic tick pulses generated by a hardware-based tick source.

An example (e.g., example 19) relates to a method comprising obtaining a cryptographic key, wherein the cryptographic key is configured to be valid for a maximum tick value, receiving a request to use the cryptographic key from a requestor, determining if the cryptographic key is valid based on the maximum tick value of the cryptographic key and a current tick value of a tick value register following the request, wherein the tick value register is configured to store a tick value based on periodic tick pulses generated by a hardware-based tick source.

Another example (e.g., example 20) relates to a previous example (e.g., example 19) or to any other example, further comprising authorizing access to the cryptographic key for the requestor if it is determined that cryptographic key is valid.

Another example (e.g., example 21) relates to a previous example (e.g., one of the examples 19 to 20) or to any other example, further comprising deleting the cryptographic key if it is determined that cryptographic key is not valid.

Another example (e.g., example 22) relates to a previous example (e.g., one of the examples 19 to 21) or to any other example, further comprising that determining if the cryptographic key as valid comprises comparing the current tick value with the maximum tick value of the cryptographic key following the request.

Another example (e.g., example 23) relates to a previous example (e.g., one of the examples 19 to 22) or to any other example, further comprising determining that the cryptographic key is valid if the current tick value is lower than the maximum tick value of the cryptographic key following the request.

Another example (e.g., example 24) relates to a previous example (e.g., one of the examples 19 to 23) or to any other example, further comprising obtaining the maximum tick value of the cryptographic key.

Another example (e.g., example 25) relates to a previous example (e.g., one of the examples 19 to 24) or to any other example, further comprising storing the cryptographic key in a secure key storage.

Another example (e.g., example 26) relates to a previous example (e.g., example 25) or to any other example, further comprising that the cryptographic key is stored in the secure key storage that is inaccessible by an operating system running on a host connected to the apparatus.

Another example (e.g., example 27) relates to a previous example (e.g., one of the examples 19 to 26) or to any other example, further comprising that the hardware-based tick source generating the periodic tick pulses comprises a clock signal based on a time signal of a processing circuitry connected to the apparatus or of a hardware-based real-time clock connected to the apparatus.

Another example (e.g., example 28) relates to a previous example (e.g., one of the examples 19 to 27) or to any other example, further comprising that the cryptographic key is a symmetric key or a private key of a private-public key pair.

Another example (e.g., example 29) relates to a previous example (e.g., one of the examples 19 to 28) or to any other example, further comprising that the tick value register is configured to increment the tick value monotonically.

Another example (e.g., example 30) relates to a previous example (e.g., one of the examples 19 to 29) or to any other example, further comprising forwarding the cryptographic key only to a cryptographic engine upon determining that the cryptographic key is valid.

An example (e.g., example 31) relates to an apparatus comprising a tick value register, configured to update a tick value based on periodic tick pulses generated by a hardware-based tick source, a processor circuitry configured to obtain a cryptographic key, wherein the cryptographic key is configured to be valid for a maximum tick value, receive a request to use the cryptographic key from a requestor, determine if the cryptographic key is valid based on the maximum tick value of the cryptographic key and the current tick value of the tick value register following the request.

An example (e.g., example 32) relates to a device comprising a tick value register, configured to update a tick value based on periodic tick pulses generated by a hardware-based tick source, means for processing for obtaining a cryptographic key, wherein the cryptographic key is configured to be valid for a maximum tick value, receiving a request to use the cryptographic key from a requestor, determining if the cryptographic key is valid based on the maximum tick value of the cryptographic key and the current tick value of the tick value register following the request.

Another example (e.g., example 33) relates to a computer program having a program code for performing the method of any one of examples 19 to 30 when the computer program is executed on a computer, a processor, or a programmable hardware component.

Another example (e.g., example 34) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for secure storage of a cryptographic key comprising:
a tick value register, configured to store a tick value based on periodic tick pulses generated by a hardware-based tick source;
machine-readable instructions and processing circuitry to execute the machine-readable instructions to:
obtain a cryptographic key, wherein the cryptographic key is configured to be valid for a maximum tick value;
receive a request to use the cryptographic key from a requestor;
determine if the cryptographic key is valid based on the maximum tick value of the cryptographic key and the current tick value of the tick value register following the request.

2. The apparatus of claim 1, wherein the processing circuitry is further to execute the machine-readable instructions to authorize access to the cryptographic key for the requestor if it is determined that cryptographic key is valid.

3. The apparatus of claim 1, wherein the processing circuitry is further to execute the machine-readable instructions to delete the cryptographic key if it is determined that cryptographic key is not valid.

4. The apparatus of claim 1, wherein determining if the cryptographic key as valid comprises comparing the current tick value with the maximum tick value of the cryptographic key following the request.

5. The apparatus of claim 1, wherein the processing circuitry is further to execute the machine-readable instructions to determine that the cryptographic key is valid if the current tick value is lower than the maximum tick value of the cryptographic key following the request.

6. The apparatus of claim 1, wherein the processing circuitry is further to execute the machine-readable instructions to obtain the maximum tick value of the cryptographic key.

7. The apparatus of claim 1, wherein the processing circuitry is further to execute the machine-readable instructions to store the cryptographic key in a secure key storage.

8. The apparatus of claim 1, further comprising a secure key storage configured to store the cryptographic key.

9. The apparatus of claim 7, wherein the cryptographic key is stored in the secure key storage that is inaccessible by an operating system running on a host connected to the apparatus.

10. The apparatus of claim 1, wherein the hardware-based tick source generating the periodic tick pulses comprises a clock signal based on a time signal of a processing circuitry connected to the apparatus or of a hardware-based real-time clock connected to the apparatus.

11. The apparatus of claim 1, further comprising a power source configured to maintain operation of the hardware-based tick source.

12. The apparatus of claim 1, further comprising a maximum tick value register being configured to store the maximum tick value of the cryptographic key.

13. The apparatus of claim 1, wherein the cryptographic key is a symmetric key or a private key of a private-public key pair.

14. The apparatus of claim 1, wherein the apparatus is configured for operation in an air-gapped environment without access to external network time services.

15. The apparatus of claim 1, wherein the tick value register is configured to increment the tick value monotonically.

16. The apparatus of claim 1, further comprising a cryptographic engine configured to perform one or more cryptographic operations using the cryptographic key.

17. The apparatus of claim 16, wherein the processing circuitry is further configured to execute the machine-readable instructions to forward the cryptographic key only to the cryptographic engine upon determining that the cryptographic key is valid.

18. A non-transitory computer-readable medium storing instructions that, when executed by one or more processing circuitries, causing the one or more processing circuitries to perform a method comprising:
obtaining a cryptographic key, wherein the cryptographic key is configured to be valid for a maximum tick value;
receiving a request to use the cryptographic key from a requestor;
determining if the cryptographic key is valid based on the maximum tick value of the cryptographic key and a current tick value of a tick value register following the request, wherein the tick value register is configured to store a tick value based on periodic tick pulses generated by a hardware-based tick source.

19. A method comprising:
obtaining a cryptographic key, wherein the cryptographic key is configured to be valid for a maximum tick value;
receiving a request to use the cryptographic key from a requestor;
determining if the cryptographic key is valid based on the maximum tick value of the cryptographic key and a current tick value of a tick value register following the request, wherein the tick value register is configured to store a tick value based on periodic tick pulses generated by a hardware-based tick source.

20. The method of claim 19, further comprising authorizing access to the cryptographic key for the requestor if it is determined that cryptographic key is valid.
